(19) United States
(12) Patent Application Publication
(10) Pub. No.: US 2002/0048438 A1
(43) Pub. Date: Apr. 25, 2002

(54) TRANSPARENT SEAM DISPLAY PANEL AND A METHOD OF MAKING A TRANSPARENT SEAM DISPLAY PANEL

(76) Inventor: JAMES T. VELIGDAN, MANORVILLE, NY (US)

Correspondence Address: REED SMITH LLP, 2500 ONE LIBERTY PLACE, 1650 MARKET STREET, PHILADELPHIA, PA, 19103, US

(21) Appl. No.: 09/318,935

(22) Filed: May 26, 1999

Related U.S. Application Data
(63) Continuation-in-part of application No. 09/116,231, filed on Jul. 16, 1998, now abandoned.

(51) Int. Cl. G02B 6/04

(52) U.S. Cl. 385/120

(57) ABSTRACT

A combination optical display having at least one transparent seam, and a method of making a combination optical panel having at least one transparent seam are disclosed, including individually coating a plurality of glass sheets, stacking the plurality of coated glass sheets, fastening each coated glass sheet to an adjoining glass sheet using an adhesive, applying pressure to the stack, curing the adhesive, cutting the stack to form a laminated optical panel having a wedge shape with an inlet face and an outlet face, repeating the individually coating, stacking, applying, curing, and cutting to form a plurality of laminated optical panels, and joining together the laminated optical panels at at least one optically transparent seam. The optically transparent seam may be formed of a liquid optical epoxy or an optical grease, and preferably has an index of refraction equivalent to that of the waveguides which form the individual panels.

### CROSS REFERENCE TO RELATED APPLICATIONS

This application is a continuation-in-part of U.S. patent application Ser. No. 09/116,231, filed Jul. 16, 1998, and entitled “TRANSPARENT SEAM DISPLAY PANEL”.

### STATEMENT REGARDING FEDERALLY SPONSORED RESEARCH OR DEVELOPMENT

This invention was made with Government support under contract number DE-AC02-98CH10886, awarded by the U.S. Department of Energy. The Government has certain rights in the invention.

### BACKGROUND OF THE INVENTION

1. Field of the Invention

The present invention is directed generally to a planar optical display, and, more particularly, to a transparent seam display panel and a method of making a transparent seam display panel.

2. Description of the Background

A typical video display screen has a width to height ratio of 4 with 525 vertical lines of resolution. An electron beam must be scanned both horizontally and vertically on the screen to form a number of pixels, which collectively form the image. Conventional cathode ray tubes have a practical limit in size and are relatively deep to accommodate the required electron gun. Larger screen televisions are available which typically include various forms of image projection for increasing the screen image size. However, such screens may experience limited viewing angle, limited resolution, decreased brightness, and decreased contrast.

Larger screen images may also be made available through the combination of several common television screens in a grid array. The image produced might then be divided into respective portions for display on a corresponding screen, thereby reproducing the original image in pieces which are then reassembled. However, the seams produced where two or more screens are joined interrupt the continuity of the original image. Furthermore, a cathode ray tube has a surrounding boundary which cannot display the image, thereby increasing the area of interruption.

Therefore, it is desirable to produce a display screen having a large viewing area, while eliminating the seams which would interrupt the continuity of the displayed image on the large viewing area.

### BRIEF SUMMARY OF THE INVENTION

The present invention is directed to a combination optical display having at least one transparent seam, including a plurality of adjoining laminated optical panels, wherein each panel is formed of a plurality of stacked optical waveguides, and at least one optical coupling which joins together the adjoining laminated optical panels at at least one optically transparent seam. The optically transparent seam may be formed of a liquid optical epoxy or an optical grease, and preferably has an index of refraction equivalent to that of the waveguides which form the individual panels.

The present invention is also directed to a method of making a combination optical panel having at least one transparent seam, which method includes individually coating a plurality of glass sheets in a substance having an index of refraction lower than that of the glass sheets, stacking the plurality of coated glass sheets, fastening each coated glass sheet to an adjoining glass sheet using an adhesive, applying pressure to the stack, curing the adhesive, cutting the stack to form a laminated optical panel having a wedge shape with an inlet face and an outlet face, repeating said individually coating, stacking, applying, curing, and cutting to form a plurality of laminated optical panels, and joining together the laminated optical panels at at least one optically transparent seam.

The present invention solves difficulties encountered in the prior art by producing a display screen having a large viewing area, while eliminating the seams which would interrupt the continuity of the displayed image on the large viewing area.

### BRIEF DESCRIPTION OF THE SEVERAL VIEWS OF THE DRAWINGS

For the present invention to be clearly understood and readily practiced, the present invention will be described in conjunction with the following figures, wherein:

FIG. 1 is an isometric view schematic illustrating a display panel;

FIG. 2 is a schematic illustrating a horizontal and vertical cross section of a waveguide used in an individual laminated optical panel;

FIG. 3 is a schematic illustrating a vertical cross section of a combination panel having at least one optically transparent seam; and

FIG. 4 is a schematic illustrating an exaggerated horizontal and vertical cross section of the combination panel with at least one transparent seam.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical optical display panel. Those of ordinary skill in the art will recognize that other elements are desirable and/or required in order to implement the present invention. However, because such elements are well known in the art, and because they do not facilitate a better understanding of the present invention, a discussion of such elements is not provided herein.

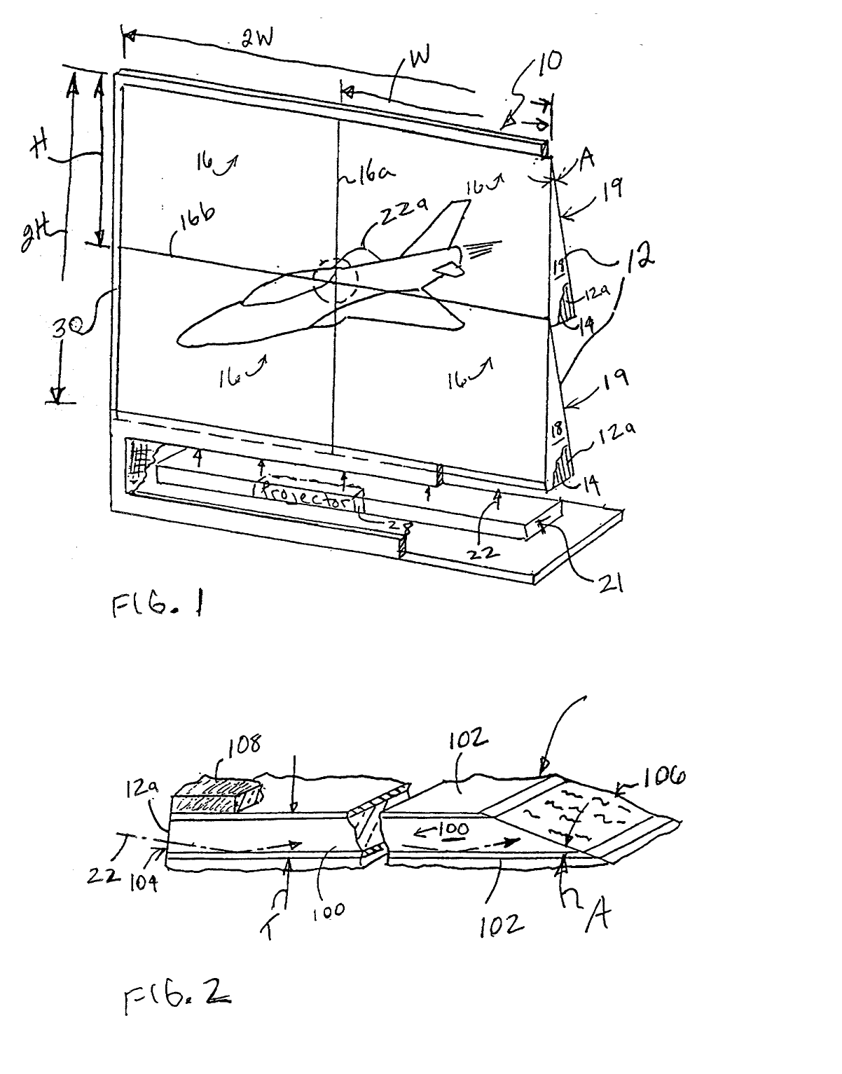

FIG. 1 is an isometric view schematic illustrating a display panel 10. The display panel 10 includes a plurality of laminated optical panels 12 joined together at a horizontal seam 16b and a vertical seam 16a, wherein each laminated optical panel is formed of a plurality of stacked optical waveguides 12a, an outlet face 16 at one end of a body 18 formed by the plurality of stacked waveguides 12a, and an inlet face 14 at a second end of the body 18. The display panel 10 also includes at least one light generator 21.

The body 18 of each laminated optical panel 12 is preferably and homogeneous, and receives light 22 along the surface of the inlet face 14. The light 22 is passed through the body 18 after entering the inlet face 14. In a preferred embodiment of the present invention, the body 18 is formed of the length, height, and width of the plurality of stacked waveguides 12a.

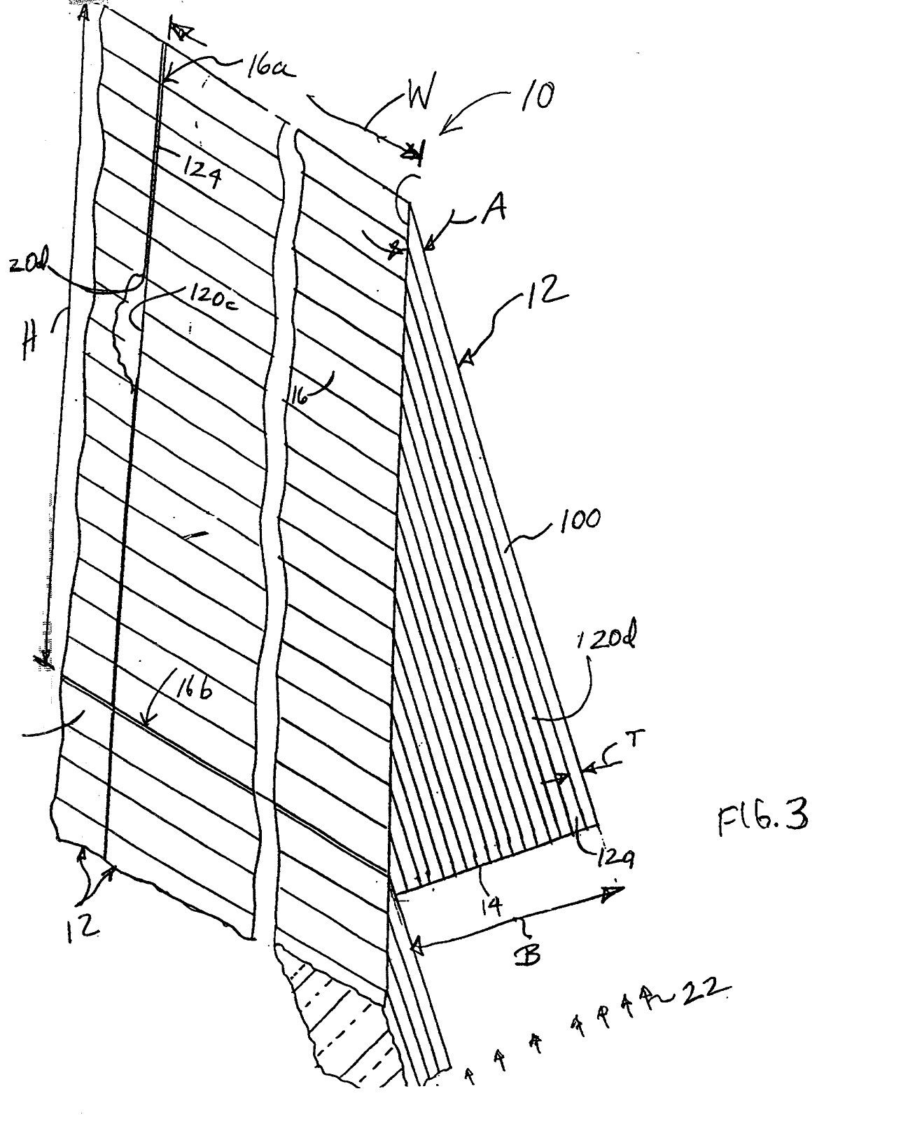

The plurality of stacked waveguides 12a forms the body 18 of each laminated optical panel 12, forms at one end of each laminated optical panel the inlet face 14, and at a second end the outlet face 16. The waveguides 12a may be formed of any material known in the art to be suitable for passing electromagnetic waves therethrough, such as, but not limited to, plastics, polymers, or glass. The preferred embodiment of the present invention is implemented using individual glass sheets, which are typically approximately 20-40 microns thick (T, as shown in FIG. 2), and which may be of a manageable length and width. However, the thickness of the individual glass sheets in the present invention may be as little as 1-2 microns. The glass used may be of a type such as, but not limited to, glass type BK7, or may be a suitable plastic laminate, such as Lexan®, commercially available from the General Electric Company®.

The inlet face 14 and outlet face 16 of each of the laminated optical panels 12 are formed by the plurality of waveguides 12a, wherein one end of each waveguide 12a forms an inlet for that waveguide, and wherein the opposite end of each waveguide 12a forms an outlet for that waveguide 12a. Each waveguide 12a extends horizontally, and the plurality of stacked waveguides 12a extends vertically, along each laminated optical panel. The light 22 may be displayed on the outlet face in a form such as, but not limited to, a video image 22a.

The outlet face 16 of each laminated optical panel 12 is formed by the plurality of stacked optical waveguides 12a. The outlet face 16 is at one end of the body 18, and is disposed obliquely with the inlet face 14. The inlet face 14 is generally defined as the bottom of the body 18, and the outlet face 16 is defined as the front of the body 18. The outlet face 16 may be generally perpendicular to the inlet face 14, forming a triangular wedge having an acute face angle A between the outlet face 16 of the body 18 and the back end 19 of the body 18. The acute face angle A may be in the range of about 5 to 10 degrees, for example, with each laminated optical panel 12 increasing in thickness from a minimum at the top of the body 18, to a maximum thickness at the bottom of the body 18. The maximum thickness may be chosen as small as is practicable in a given application. Each laminated optical panel 12 has a height from the top to the bottom of the outlet face 16, and a width from the left to the right of the outlet face 16. The width and height of each laminated optical panel 12 may be selected to produce width to height aspect ratios of 4:3 or 16:9, for example, for use in a typical television application. The design choice will create the same typical television width to height ratios if a square grid (2×2, or 4×4, for example) of the individual laminated optical panels 12 is used to form the panel 10. Thus, where a 2×2 grid is used, for example, the viewing area of the collective outlet face 16 may be quadrupled while maintaining the 4:3 aspect ratio. In an exemplary embodiment of the present invention, a maximum thickness in the range of about 4 to 8 cm may be chosen for each laminated optical panel 12, in conduction with a height of 100 cm and a width of 133 cm, thus creating a thin collective panel 10 with a large collective outlet face 16.

The light generator 21 generates light 22 and passes the light 22 to inlet faces 14 of each of the plurality of laminated optical panels 12. The light generator may include at least one projector 28. The light 22 may be initially generated by the at least one projector 28. Alternatively, the light generator may include a light source in the form of a bright incandescent bulb, a laser, a plurality of phosphors, at least one LED, at least one OLED, or at least one FED. The light 22 from the light source may then be modulated by a modulator included in the light generator 21 for defining individual picture elements, known in the art as pixels. The modulator may take a form known in the art, such as, but not limited to, a liquid crystal display (LCD), a Digital Micromirror Device (DMD), a CRT, a raster scanner, or a vector scanner. The light generator may also include a plurality of imaging optics. The plurality of imaging optics may include light folding mirrors or lenses, which are optically aligned between the inlet face 14 and the projector 28 or modulator for compressing or expanding and focusing the light 22 as required to fit the inlet face 14. The light 22, after entry into the inlet face 14, travels through the panel body 18 to the outlet face 16. In a preferred embodiment of the present invention, one light generator 21 is present for each laminated optical panel 12 used in the panel 10, to provide light to the inlet face 14 of that corresponding laminated optical panel 12. In alternative embodiments of the present invention, one light generator may be present to provide light to all inlet faces 14 of all laminated optical panels 12, or two or more light generators may be present to provide light to each inlet face 14.

Each laminated optical panel 12 of the present invention may include at least one light redirective element (not shown) connected at the outlet face 16 in order to redirect the light 22, which is incident in a direction generally vertically upward from the inlet face 14 of the laminated optical panel 12, to a direction perpendicular to the outlet face 16. The light redirective element may be, but is not limited to, a serration, a plurality of serrations, a holographic coating, a lens or series of lenses, a micro-lens or series of micro-lenses, or a Fresnel prism.

A plurality of laminated optical panels 12, as described hereinabove, are joined together in a grid array in a supporting housing or frame 30, and may be fastened using mechanical clamps, to form the larger display panel 10 of the present invention. The plurality of laminated optical panels 12 are optically joined together by at least one optically transparent seam 16a, 16b. In the exemplary configuration of the present invention illustrated, there are four individual laminated optical panels 12 arranged in a 2×2 grid array, which 2×2 grid defines a collective outlet face 16 formed of the individual outlet faces 16 of the individual laminated optical panels 12. A bottom pair of the laminated optical panels 12 laterally adjoin each other at an optically transparent vertical seam 16a, and a top pair of the laminated optical panels 12 similarly laterally adjoin each other at an optically transparent vertical seam 16a vertically aligned with the vertical seam 16a between the top pair of laminated optical panels 12. In one embodiment of the present invention, the transparency of the vertical seams 16a occurs at normal viewing distances from the collective outlet faces 16, thereby allowing the construction of large display panels 10 with a substantially continuous image not interrupted by visible seams. To create the effect of a continuous image, the collective outlet faces 16 of both the top pair and the bottom pair are preferably coplanar, or curved with coplanar tangency points.

FIG. 2 is a schematic illustrating a horizontal and vertical cross section of a waveguide 12a used in an individual laminated optical panel 12. The waveguide 12a includes a cental core 100 laminated between cladding layers 102, a receiving end 104, and an outlet end 106. The central core 100 channels the image light 22 through the waveguide 12a, is disposed between cladding layers 102, and extends from the receiving end 104 to the outlet end 106. The central core 100 is, in the preferred embodiment, a glass sheet of thickness T in the range between 20 and 40 microns, as discussed hereinabove. The central core 100 has a first index of refraction. The cladding layers 102 also extend from the receiving end 104 to the outlet end 106. The cladding layers 102 may be black in color to improve contrast and brightness. Alternatively, a black layer 108 may be disposed between adjoining cladding layers 102 for absorbing ambient light at the outlet end 106, where the adjoining cladding layers 102 are transparent. The cladding layers 102 have a second index of refraction, lower than that of the central core 100, for ensuring total internal reflection of the image light 22 as it travels from the receiving end 104 to the outlet end 106.

The waveguide 12a is in the form of a sheet or a ribbon extending from the receiving end 104 to the outlet end 106 of each laminated optical panel 12. The plurality of waveguides 12a form at their collective receiving ends 104 the inlet face 14 of FIG. 1, and at their collective outlet ends 106 the outlet face 16 of FIG. 1. The number of waveguides 12a may be selected for providing a corresponding vertical resolution of an individual or collective outlet face 16. For example, 525 of the waveguides 12a may be stacked to produce 525 lines of vertical resolution in an individual outlet face 16, and a corresponding resolution in the collective outlet face 16.

The plurality of stacked waveguides 12a may be made by several methods to form an individual laminated optical panel 12. A plurality of glass sheets may be individually coated with, or dipped within, a substance having an index of refraction lower than that of the glass, and a plurality of coated sheets may then be fastened together using glue or thermally curing epoxy. Alternatively, the glue or epoxy could form the cladding layers and be applied directly to the glass sheets. In one embodiment of the present invention, a first coated or uncoated glass sheet is placed in a trough sized slightly larger than the first coated glass sheet, the trough is filled with a thermally curing black epoxy, and the coated or uncoated glass sheets are repeatedly stacked, forming a layer of epoxy between each coated or uncoated glass sheet. The stacking is preferably repeated until between approximately 500 and 800 sheets have been stacked. Uniform pressure may then be applied to the stack, followed by a cure of the epoxy, and a sawing of the laminated optical panel 12 into a wedge shape having an inlet face 14 and an outlet face 16. The faces 14, 16 may be sawed curved or flat, and may be frosted or polished after sawing. In an alternative method, the glass sheets preferably have a width in the range between 0.5″ and 1.0″, and are of a manageable length, such as 12″. The coated glass sheets are stacked, and a layer of black UV adhesive is placed between each sheet. Ultraviolet radiation is then used to cure each adhesive layer, and the stack may then be cut and/or polished as discussed hereinabove.

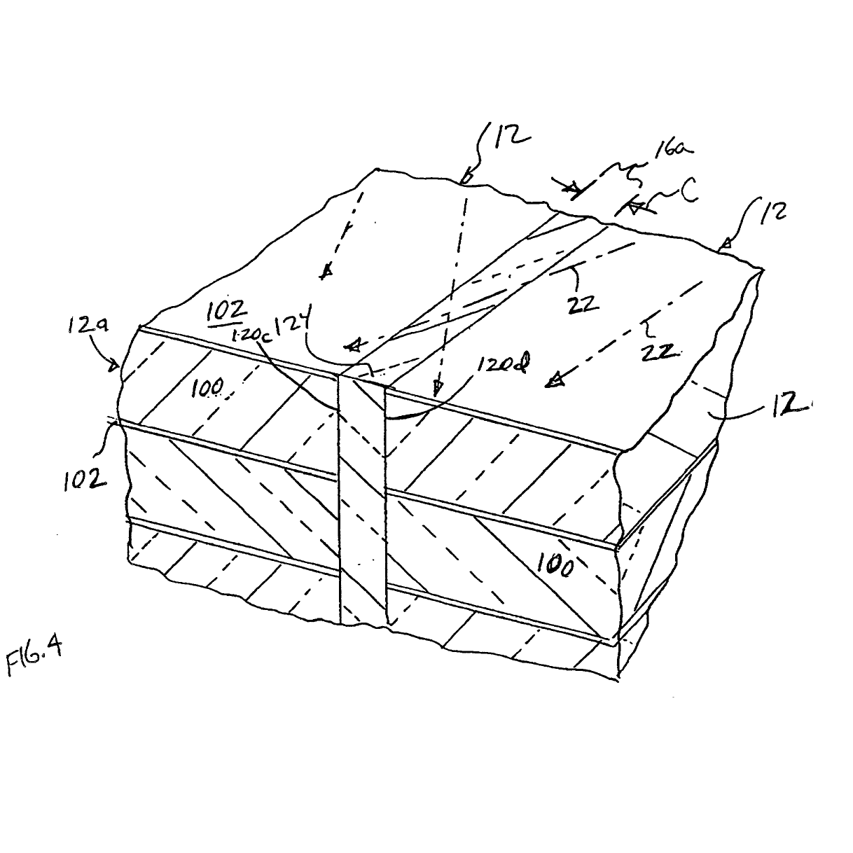

FIG. 3 is a schematic illustrating a vertical cross section of a combination panel 10 having at least one optically transparent seam 16a, 16b. The combination panel 10 includes at least two laminated optical panels 12, each formed of a plurality of optical waveguides 12a as illustrated with respect to FIG. 1 and FIG. 2, at least one collective inlet face 14, a collective outlet face 16, and at least one optically transparent seam 16a, 16b which joins the outlet faces 16 of the individual laminated optical panels 12 at the collective outlet face 16.

In the illustrated embodiment, the top at least two panels 12 in a square grid vertically adjoin the bottom at least two panels 12 at a horizontal seam 16b. The horizontal seam 16b illustrated perpendicularly intersects the vertical seam 16a. In a preferred embodiment of the present invention, at least two transparent seams 16a, 16b are present at the joinder points of at least four individual laminated optical panels 12. However, in other embodiments of the present invention, as few as one transparent seam may be present, where two individual panels 12 are used to form the collective outlet face 16, or as many transparent seams may be present as correspond to a suitable number of individual panels 12 in a given application. The individual waveguides 12a are continuous in their width to allow full lateral distribution of the light between the lateral edges 120c, 120d of the individual laminated optical panels 12. The only physical interruption in the lateral distribution of the light 22 is at the vertical seam 16a, where lateral edges 120c, 120d of individual panels 12 meet. Thus, the vertical seam 16a includes a coupling material 124, which coupling material 124 creates an optically transparent interface between lateral edges 120c, 120d, thereby creating the optical effect of one uninterrupted waveguide. In this manner, the present invention allows uninterrupted horizontal resolution across at least two individual panels 12.

The horizontal seam 16b is defined by the abutting contact of the adjacent cladding layers 102 of the outermost waveguides 12a of the adjoining individual panels 12. A double-thickness cladding layer 102 is effected at the horizontal seam 16b due to the joinder at the seam of the adjacent cladding layers 102 of the outermost waveguides 12a, but such a double thickness cladding layer 102 is substantially invisible to the viewer due to the small thickness of the individual cladding layers 102, which thickness is on the order of several microns. In one embodiment of the present invention, the transparent coupling material 124 may be introduced into the horizontal seam 16b in the form of an adhesive, for example, to maintain accurate alignment between the adjoining individual panels 12.

The coupling material 124 for the vertical seam 16a and for the horizontal seam 16b is preferably identical and may be an adhesive, or liquid, or a suitable grease. An adhesive coupling 124 having the same index of refraction as that of the waveguide cores 100 not only allows unaffected light transmission therethrough, but is additionally effective for fixedly bonding together the adjoining panels 12 along the vertical seam 16a. A suitable optical grade epoxy adhesive having a refractive index of 1.52, to match that of the glass sheets used in a preferred embodiment, is designated Epo-Tek 301 and is available from Epoxy Technology Inc., Billerica, Mass. The coupling material 124 may, in another embodiment of the present invention, be a suitable optical grease, such as that available from R.P. Cargille Company of Cedargrove, N.J., under product designation “1.520.” The advantage of grease, or a suitable liquid, is the temporary nature of the adhesion of the optical coupling provided at the seams 16a, 16b, which temporary nature is useful in large portable displays which are temporarily assembled and then disassembled when no longer needed.

Each panel 12 may be separately manufactured in the specific triangular configuration illustrated with respect to FIG. 1, with the individual panels 12 being preferably similar in configuration. Similar configurations allow the horizontally adjoining panels 12 to have their respective inlet faces 14 horizontally aligned in a common plane. However, the inlet faces 14 of the vertically adjoining panels 12 may be vertically staggered from one another where the inlet face 14 of the top panel 12 terminates at an overlap point proximate the top of the bottom panel 12 and is therefore vertically displaced above the inlet face 14 of the bottom panel 12. In an alternative embodiment of the present invention, the waveguides 12a of the top panel 12 may be extended to place the inlet face 14 of the top panel 12 in the same horizontal plane as the inlet face 14 of the bottom panel 12. In a preferred embodiment of the present invention, a light generator 21, as discussed with respect to FIG. 1, is present at each inlet face 14. Alternatively, a single light generator 21 may provide light to all of the several inlet faces, where the single light generator 21 is suitably focused to project the light 22 into all of the several inlet faces 14. In a second alternative embodiment of the present invention, two or more light generators 21 may be provided to provide light to three or more inlet faces 14.

FIG. 4 is a schematic illustrating a horizontal and vertical cross section of the combination panel 10 with at least one transparent seam 16a, 16b. FIG. 4 shows greatly exaggerated the spacing between the edges of the adjacent waveguides 12a for clarity of presentation.

The lateral edges 120c, 120d of the waveguides 12a, which meet at the seam 16a, are preferably manufactured as flat and smooth as practical, and may be optically polished if desired. In accordance with a preferred embodiment of the present invention, the optical coupling 124 optically couples the lateral edges 120c, 120d to allow internal transmission of the light 22 across the vertical seam 16a without reflection or refraction which would be visible to a viewer. The vertical seam 16a has a width C, which is formed of the thickness of the coupling 124 itself, which width C is preferably as small as practical, and is preferably in the range of about 1 to 10 microns.

In the preferred embodiment of the present invention, the coupling 124 and the core 100 of each waveguide 12a have an equal index of refraction for allowing unaffected light transmission laterally between the adjoining panels 12 and through the vertical seams 16a, thereby rendering the vertical seams 16a transparent during light projection. In this manner, the light image 22a (see FIG. 1) may be viewed in its entirety across the several individual panels 12 without discontinuity across the vertical seam 16a or the extremely small horizontal seam 16b.

Those of ordinary skill in the art will recognize that many modifications and variations of the present invention may be implemented. For example, a number of substances known in the art may be used as the optical coupling material, while still producing a substantively similar collective panel. The foregoing description and the following claims are intended to cover all such modifications and variations.

What is claimed is:

1. An combination optical display, comprising:
a plurality of adjoining laminated optical panels, wherein each panel is formed of a plurality of stacked optical waveguides; and
at least one optical coupling which joins together said adjoining laminated optical panels at at least one optically transparent seam.

2. The combination optical display of claim 1, wherein each of said laminated optical panels is formed in a wedge shape, having an outlet face, an inlet face disposed obliquely with the inlet face, a back, and two lateral edges.

3. The combination optical panel of claim 2, further comprising at least one light generator.

4. The combination optical panel of claim 3, wherein said at least one light generator includes a projector.

5. The combination optical panel of claim 3, wherein said at least one light generator includes:
a light source;
a light modulator; and
imaging optics.

6. The combination optical panel of claim 5, wherein the light source is chosen from the group consisting of a bright incandescent bulb, a laser, a plurality of phosphors, at least one LED, at least one OLED, and at least one FED.

7. The combination optical panel of claim 3, wherein one light generator is present for each laminated optical panel used in the combination optical panel.

8. The combination optical panel of claim 3, wherein light from said at least one light generator is passed to the inlet face, and displayed on the outlet face as a light image.

9. The combination optical panel of claim 2, wherein the outlet face is generally perpendicular to the inlet face, forming a wedge having shape having an acute face angle in the range between about 5 degrees and 10 degreess between the outlet face and the back.

10. The combination optical panel of claim 2, wherein each laminated optical panel has a height from a top to a bottom of the outlet face, and a width from a left side to a right side of the outlet face, and wherein the width to height aspect ratio is 4:3.

11. The combination optical panel of claim 2, wherein the outlet face of each optical panel includes at least one light redirective element to redirect light perpendicular to a viewer.

12. The combination optical panel of claim 11, wherein the at least one light redirective element is chosen from the group consisting of a plurality of serrations, a holographic coating, at least one lens, at least one micro-lens, and a Fresnel prism.

13. The combination optical panel of claim 2, wherein the inlet faces of horizontally adjoining panels are horizontally aligned in a common plane.

14. The combination optical panel of claim 2, wherein the inlet faces of vertically adjoining panels are vertically staggered.

15. The combination optical panel of claim 2, wherein the inlet faces of vertically adjoining panels are horizontally aligned in a common plane.

16. The combination optical panel of claim 2, wherein said optical coupling optically couples the lateral edges of the waveguides of adjoining panels.

17. The combination optical panel of claim 1, wherein each waveguide includes:
opposed cladding layers;
a cental core disposed between said cladding layers;
a receiving end; and
an outlet end.

18. The combination optical panel of claim 17, wherein the central core is formed of a material chosen from the group consisting of a plastic laminate, a polymer, and a glass sheet.

19. The combination optical panel of claim 18, wherein the waveguides are formed of glass sheets having a thickness in the range of about 1 to about 19 microns.

20. The combination optical panel of claim 18, wherein the waveguides are formed of glass sheets having a thickness in the range of about 20 to about 40 microns.

21. The combination optical panel of claim 18, wherein the waveguides are formed of glass sheets of type BK7.

22. The optical panel of claim 17, wherein the cladding layers have a second index of refraction lower than a first index of refraction of the central core.

23. The combination optical panel of claim 1, wherein said plurality of laminated optical panels are arranged in a square grid.

24. The combination optical panel of claim 23, wherein the square grid is 2 laminated optical panels by 2 laminated optical panels.

25. The optical panel of claim 1, further comprising a supporting frame in which said plurality of laminated optical panels are fastened.

26. The optical panel of claim 25, wherein said plurality of laminated optical panels are fastened using mechanical clamps.

27. The optical panel of claim 1, wherein about 525 of the waveguides are stacked.

28. The optical panel of claim 1, wherein at least two seams are present at the joinder of at least four of said laminated optical panels arranged in a square grid.

29. The optical panel of claim 28, wherein said optical coupling is present in each of the seams.

30. The optical panel of claim 29, wherein said optical coupling is an adhesive.

31. The optical panel of claim 1, wherein said optical coupling is chosen from the group consisting of liquid optical epoxy and optical grease.

32. The optical panel of claim 31, wherein said coupling material has an index of refraction substantially equivalent to that of the waveguides.

33. The optical panel of claim 32, wherein said coupling material has an index of refraction of about 1.52.

34. The optical panel of claim 1, wherein the transparent seam has a width in the range of about 1 to about 10 microns.

35. A method of making a combination optical panel, comprising:
individually coating a plurality of glass sheets in a substance having an index of refraction lower than that of the glass sheets;
stacking the plurality of coated glass sheets, wherein each coated glass sheet is fastened to an adjoining glass sheet using an adhesive;
applying pressure to the stack;
curing the adhesive;
cutting the stack to form a laminated optical panel having a wedge shape with an inlet face and an outlet face;
repeating said individually coating, stacking, applying, curing, and cutting to form a plurality of laminated optical panels;
joining together said plurality of laminated optical panels at at least one optically transparent seam.

36. The method of claim 35, wherein said stacking is repeated until between about 500 and about 800 sheets have been stacked.

37. The method of claim 35, further comprising polishing the inlet face and the outlet face of each laminated optical panel after cutting.

38. The method of claim 35, further comprising frosting the outlet face of each laminated optical panel after cutting.

39. The method of claim 35, further comprising generating light and passing the light to the inlet face of each laminated optical panel.

40. The method of claim 35, wherein 4 laminated optical panels are joined together at 2 optically transparent seams.

41. The method of claim 35, wherein said joining together includes:
applying an optical coupling material to the plurality of laminated optical panels, where the optical coupling material has an index of refraction approximately equivalent to that of the glass sheets; and
fastening said plurality of laminated optical panels using said optical coupling material.

42. The optical panel of claim 41, wherein said optical coupling material is chosen from the group consisting of liquid optical epoxy and optical grease.
